(19) United States
(12) Patent Application Publication
(10) Pub. No.: US 2021/0219527 A1
(43) Pub. Date: Jul. 22, 2021

(54) NETTING FOR AQUACULTURE

(71) Applicant: TEIJIN ARAMID B.V., Arnhem (NL)

(72) Inventors: Gerardus JANSE, Maasbracht (NL); Ben ROLINK, Ugchelen (NL)

(73) Assignee: Teijin Aramid B.V., Arnhem (NL)

(21) Appl. No.: 17/053,947

(22) PCT Filed: May 15, 2019
(86) PCT No.: PCT/EP2019/062475

§ 371 Date: Nov. 9, 2020

(30) Foreign Application Priority Data
May 18, 2018 (EP) 18173147.2

(51) Int. Cl. A01K 61/60; A01K 75/00

(52) U.S. Cl. CPC A01K 61/60; A01K 75/00

(57) ABSTRACT

Netting suitable for use in aquaculture which has a half mesh size of 5-100 mm measured in accordance to ISO 1107:2017 and includes cord having a diameter of 0.5-8 mm, wherein the cord includes films of ultra-high molecular weight polyethylene, the films having a width of 0.5-10 mm. It has been found that the use of cord based on films of ultra-high molecular weight PE (UHMWPE) results in nets with improved fouling resistance compared to nets based on conventional ultra-high molecular weight gel-spun monofilament or multifilament yarn. The netting is easier to clean than netting based on conventional ultra-high molecular weight gel-spun monofilament or multifilament yarn. Not only is less frequent cleaning required due to less fouling, the cleaning steps themselves can be carried out at lower water pressure in the high-pressure cleaning apparatus. This results in less damage of the nets during cleaning and lower water consumption.

The present invention pertains to netting suitable for use in aquaculture.

With the ongoing trend of pursuing fish production at more offshore and remote locations, especially in marine aquaculture, in the world and prevailing concerns of sustainability of current fishing operations, netting used in fish farming (also indicated as aquaculture) has to meet more and more stringent requirements. These include high strength in combination with low weight and high durability under harsh conditions, including prolonged exposure to sea water and sun. Accordingly, there is a trend in aquaculture to move from relatively inexpensive netting based on polyamides, in particular Nylon, to netting based on more durable materials, such as such as high molecular weight polyethylene or high density polyethylene.

It has been found, however, that there are various issues with existing netting for aquaculture based on polyethylene. One issue is that of net fouling. Nets in aqueous environment have been found to be susceptible to the undesired growth of organisms, ranging from microorganisms to larger organisms such as algae, seaweed, and others. The presence of these organisms may be detrimental to the health of the fish in fish farming. Additionally, the presence of fouling organisms increases the weight of the net, and given the large size of nets used in aquaculture, this weight increase may be substantial, resulting in a worst-case scenario in collapse of the net or the entire aquaculture cage. Fouling is a particular issue in aquaculture and where nets, in order to be strong enough, are used based on relatively thick cords, which thus have a relatively large surface to attract bio-fouling particles. Additionally, the nets remain in place for a relatively long period of time. Therefore, reduction of net fouling is an important problem to be solved.

In the art, finishes have been used to improve the antifouling properties of nets. Reference is made to WO2014/056980 which describes an antifouling composition for use on netting in aquaculture containing a cross-linked silicon polymer. The presence of finishing on netting has a number of disadvantages pertaining in particular to loss of finish. In the first place, loss of finish will result in loss of antifouling resistance of the net. Further, loss of finish in the water is highly undesirable from an environmental point of view as it has a negative impact on the health of fish but also to the environment. Currently, majority of anti-fouling agents are based on copper oxide, which represents a serious environmental hazard to the fish living inside of the pen but also to the surrounding environment. Ironically, cleaning of netting to remove fouling can also result in removal of finish which leads to increased fouling sensitivity of the netting. In addition, applying anti-fouling agents to nets increases the whole costs of fish farming operations.

Accordingly, there is need in the art for netting suitable for use in aquaculture which is less susceptible to fouling, requires less frequent cleaning, is easy to clean, retains its antifouling properties after cleaning and does not have to be provided with an antifouling finish. The present invention provides such a netting.

The invention pertains to netting suitable for use in aquaculture which has a half mesh size of 5-100 mm measured in accordance to ISO 1107:2017 and which comprises cord having a diameter of 0.5-8 mm, wherein the cord comprises films of ultra-high molecular weight polyethylene, the films having a width of 0.5-10 mm.

It has been found that the use of a cord based on films of ultra-high molecular weight PE (UHMWPE) results in nets with improved fouling resistance as compared to nets based on conventional ultra-high molecular weight gel-spun monofilament or multifilament yarn. It has also been found that the netting according to the invention is easier to clean than netting based on conventional ultra-high molecular weight gel-spun monofilament or multifilament yarn. Not only is less frequent cleaning required due to less fouling, the cleaning steps themselves can be carried out at lower water pressure in the high-pressure cleaning apparatus. This results in less damage of the nets during cleaning and lower water consumption. Additional advantages of the present invention and specific embodiments thereof will become evident from the further specification.

The invention will be discussed in more detail below.

The invention pertains to netting suitable for use in aquaculture which has a half mesh size of 5-100 mm measured in accordance to ISO 1107:2017. It may be preferred for the half mesh size to be in the range of 10-70 mm, in particular in the range of 10 to 30 mm.

The cord used in the netting has a diameter of 0.5-8 mm. It may be preferred for the cord to have a diameter of 1-6 mm, in particular 2-5 mm.

The cord used in the netting generally has a linear density of 500 to 500000 dtex, more preferably 1000 to 200000 dtex, even more preferably 4000 to 80000 dtex.

Films of UHMWPE have been described in the art.

For example, WO2009007045 describes a UHMWPE film having a tensile strength of at least 2.0 GPa, a tensile energy to break of at least 30 J/g, an Mw of at least 500 000 gram/mole, and a Mw/Mn ratio of at most 6. It mentions the possible use of the films described therein in many applications, including ballistic applications, ropes, cables, fabrics, protective applications and nets. The use in nets is not further described and also encompasses heavy duty applications such as cargo nets and nets which are to protect from RPGs (rocket propelled grenades).

The UHMWPE films used in the present invention have a width in the range of 0.5-10 mm. Films with a width below 0.5 mm will require the use of a larger number of films to obtain the desired cord diameter, which may detrimentally affect the fouling resistance of the net. Films with a width above 10 mm may be difficult to convert in a homogeneous cord, which again may detrimentally affect fouling resistance. It may be preferred for the film width to be at least 1 mm. It may also be preferred for the film width to be at most 8 mm, in particular at most 6 mm.

The film generally has a thickness in the range of 10-150 micron. Thinner films have the advantage that they may have a relatively high strength per using of weight, making for a relatively stronger cord. On the other hand, thicker films may make it possible to obtain the desired cords thickness with fewer films, which may lead to improved antifouling performance. To balance these properties, it may be preferred for the film to have a thickness in the range of 20-100 micron, in particular in the range of 30-90 micron.

The film generally has a linear density in the range of 250 dtex to 5000 dtex, in particular of 500 to 2000 dtex.

The film generally has a specific surface area of at least 10 mm⁻¹, more preferably at least 15 mm⁻¹, even more preferably at least 20 mm⁻¹. The specific surface area of a film is the surface area of the film per volume of the film. The film generally has a specific surface area of less than 100 mm⁻¹, more preferably less than 80 mm⁻¹, even more preferably less than 60 mm⁻¹. A specific surface area of below 100 mm⁻¹ ensures little surface availability for fouling, while a specific surface area above 10 mm⁻¹ ensures sufficient processability of the film.

The film may be used as such, in which case the cord corresponds to the film. It can also be used after twisting and/or braiding. The number of films present in the cord will depend on the cord construction, cord diameter, and linear density and on the film width and thickness.

In general, the number of films in the cord will be in the range of 1 to 500. It may be preferred for the number of films in the cord to be in the range of 3-100, more preferably 5-50.

Multiple films may be twisted or braided, in one or more steps to form a cord. For example, a limited number of films, say 1-12 or 1-10, may be twisted together to form a strand, and a number of strands, e.g., 3-10 are twisted or braided together or processed through raschel knitting to form a cord.

It is possible for the films to be interconnected through fibrils, e.g., when they are derived from splitting a wider film through the process described in WO2017148628. Where a film is connected to other films through filaments, the individual films have to meet the film requirements stipulated herein.

The cord used in the netting according to the invention comprises ultra-high molecular weight polyethylene film. The cord may also comprise other fiber or film like materials, such as nylon fibers or metal strands, to provide additional properties to the netting. It is preferred, however, for the cord to consist for at least 50 wt.% of UHMWPE film specified herein, in particular at least 70 wt. %, more in particular at least 90 wt. %, even more in particular at least 95 wt. %, even more in particular at least 99 wt. % and even more in particular at least 99.5 wt. %. It is possible to use cords with different compositions on different parts of the netting (e.g., the part of the netting nearer to the sea surface versus the part of the netting which will be immersed deeper).

Preferably, the films and cords are not provided with any organic or polymeric resin, such as polyolefin resin or more specifically ethylene/propylene copolymer resin of low melting point, as there is a risk of releasing these compounds into the environment. It is therefore preferred, both for the film and the cord, to consist for at least 95 wt. %, in particular at least 98 wt. %, more in particular at least 99 wt. %, more in particular at least 99.5 wt. % and even more in particular at least 99.9 wt. % of UHMWPE.

The netting will be manufactured by methods known in the art. The nets can be knotted nets or knotless nets. These methods are known in the art and require no further elucidation here.

The films used in the present invention are films of ultra-high molecular weight polyethylene (UHMWPE).

The films used in the present invention preferably have a tensile strength of at least 1.0 GPa, a tensile modulus of at least 40 GPa, and a tensile energy-to-break of at least 15 J/g. In one embodiment, the tensile strength of the films is at least 1.2 GPa, more in particular at least 1.5 GPa, still more in particular at least 1.8 GPa, even more in particular at least 2.0 GPa. In some embodiments, the tensile strength is at least 2.5 GPa, more in particular at least 3.0 GPa, still more in particular at least 4 GPa. Tensile strength is determined in accordance with ASTM D882-00.

In another embodiment, the films have a tensile modulus of at least 50 GPa. The modulus is determined in accordance with ASTM D822-00. More in particular, the films may have a tensile modulus of at least 80 GPa, more in particular at least 100 GPa, in some embodiments at least 120 GPa, even more in particular at least 140 GPa, or at least 150 GPa.

In another embodiment, the films have a tensile energy to break of at least 20 J/g, in particular at least 25 J/g. In some embodiments, the films have a tensile energy to break of at least 30 J/g, in particular at least 35 J/g, more in particular at least 40 J/g, still more in particular at least 50 J/g. The tensile energy to break is determined in accordance with ASTM D882-00 using a strain rate of 50%/min. It is calculated by integrating the energy per unit mass under the stress-strain curve.

The films used in the present invention are ultra-high molecular weight polyethylene films, in particular high-drawn films of ultra-high-molecular weight polyethylene. The polyethylene used in this embodiment of the present invention can be a homopolymer of ethylene or a copolymer of ethylene with a co-monomer which is another alpha-olefin or a cyclic olefin, both with generally between 3 and 20 carbon atoms. Examples include propene, 1-butene, 1-pentene, 1-hexene, 1-heptene, 1-octene, cyclohexene, etc. The use of dienes with up to 20 carbon atoms is also possible, e.g., butadiene or 1-4 hexadiene. The amount of non-ethylene alpha-olefin in the ethylene homopolymer or copolymer used in the process according to the invention preferably is at most 10 mole %, preferably at most 5 mole %, more preferably at most 1 mole %. If a non-ethylene alpha-olefin is used, it is generally present in an amount of at least 0.001 mol. %, in particular at least 0.01 mole %, still more in particular at least 0.1 mole %. The use of a material which is substantially free from non-ethylene alpha-olefin is preferred. Within the context of the present specification, the wording substantially free from non-ethylene alpha-olefin is intended to mean that the only amount non-ethylene alpha-olefin present in the polymer are those the presence of which cannot reasonably be avoided.

Ultra-high molecular weight here means a weight average molecular weight of at least 500 000 g/mol. The use of films with a molecular weight of at least 1*10⁶ g/mol may be particularly preferred. The maximum molecular weight of the UHMWPE films suitable for use in the present invention is not critical. As a general value a maximum value of 1*10⁸ g/mol may be mentioned. The molecular weight distribution and molecular weigh averages (Mw, Mn, Mz) are determined in accordance with ASTM D 6474-99 at a temperature of 160° C. using 1,2,4-trichlorobenzene (TCB) as solvent. Reference is made to WO2009/109632 for a suitable determination method.

In a preferred embodiment of the present invention the polyethylene films have a high molecular orientation as is evidenced by their XRD diffraction pattern. In one embodiment, the films have a 200/100 uniplanar orientation parameter of at least 3.

The uniplanar orientation parameter gives information about the extent of orientation of the 200 and 110 crystal planes with respect to the planar film surface. In other words, the uniplanar orientation is a measure of the degree of orientation of a crystal plane, viz the 200 plane of the PE crystallites, with respect to the planar surface of the tape. In fibers obtained by gel-spun polymerization, the crystals will be oriented in the stretching direction of the fiber. Therefore, in fibers obtained through gel-spun polymerization, there is no uniplanar orientation since there is no planar surface. Accordingly, the 200/110 uniplanar orientation parameter is low, e.g. of the order of 0.3.

It may be preferred for the 200/100 uniplanar orientation parameter of the film used in the present invention to be at least 4, more in particular at least 5, or at least 7. Higher values, such as values of at least 10 or even at least 15 may also be obtained. The theoretical maximum value for this parameter may be as high as infinite if the peak area 110 equals zero. This parameter can be determined as described in WO2009/109632.

In one embodiment of the present invention, the UHMWPE films have a DSC crystallinity of at least 74%, more in particular at least 80%. In one embodiment, the films used in the present invention have a DSC crystallinity of at least 85%, more in particular at least 90%.The DSC crystallinity can be determined as described in WO2009/109632.

In general, the UHMWPE films used in the present invention have a polymer solvent content of less than 0.05 wt. %, in particular less than 0.025 wt. %, more in particular less than 0.01 wt. %. This is characteristic of UHMWPE films obtained through solid-state processing, rather than through gel-spinning.

Solvents for UHMWPE are known in the art. They generally have a chi-parameter for polyethylene of less than 0.5, in particular less than 0.45, more in particular less than 0.4, and most preferably less than 0.35. Chi-parameters can, e.g., be found in Chapter 14, Polymer-Solvent Interaction Parameter Chi, by R. A. Orwol; and P. A. Arnold, of Physical Properties of Polymers Handbook, ed. J. E. Mark, AIP Press, New York, 1996. Examples of polymer solvents for UHMWPE include higher aliphatic hydrocarbons such as decane, and paraffins, aromatic hydrocarbons such as toluene and xylene, and hydrogenated aromatic compounds such as decaline or tetraline.

In general, the UHMWPE films and cords used in the present invention are substantially free from finishes and antifouling agents, wherein the term substantially free means that no finish or antifouling agent has been added.

UHMWPE films suitable for use in the present invention can, e.g., be obtained through solid-state film manufacturing process comprising the steps of subjecting a starting ultra-high molecular weight polyethylene to a compacting step and a stretching step under such conditions that at no point during the processing of the polymer its temperature is raised to a value above its melting point. The compacting step is carried out to integrate the polymer particles into a single object, e.g., in the form of a mother sheet. The stretching step is carried out to provide orientation to the polymer and manufacture the final product. The two steps are carried out at a direction perpendicular to each other. These elements may be combined in a single step, or carried out in different steps, each step performing one or more of the compacting and stretching elements. For example, in one embodiment of the process according to the invention, the process comprises the steps of compacting the polymer powder to form a mothersheet, rolling the plate to form rolled mothersheet and subjecting the rolled mothersheet to a stretching step to form a polymer film. A suitable method for manufacturing polyethylene films is described in WO2009/153318.

Where appropriate, broader tapes may be slit or split into narrower tapes at any point in time during the processing step, more in particular after stretching, between intermediate stretching steps, and before stretching. The slitting or splitting may be carried out by means known in the art, e.g., using knives, or as described in WO 2010/003971.

The invention also pertains to the use of the netting described herein in aquaculture, and to a method for culturing fish, wherein fish are cultured in a fish pen comprising netting described herein. The method of aquaculture and the use of netting therein is known in the art, and requires no further elucidation here.

As will be evident to the skilled person, preferred embodiments of various aspects of the present invention can be combined, unless they are mutually exclusive.

The invention will be elucidated by the following example, without being limited thereto or thereby.

### EXAMPLE 1

Netting according to the invention was prepared from cord based on UHMWPE film having a width of 2 mm and a thickness of 60 micron. The film had a polymer solvent content of less than 0.05 wt. %, and a weight average molecular weight in the range of 5-8 10\hat{ }6 g/mole. The film had a modulus of 180 N/tex and a linear density of 950 dtex. The film is commercially available under the tradename Endumax from Teijin Endumax. Cords were prepared by twisting 10 films together to form a strand, and combining 4 strands to form a cord. The cord had a diameter of 3.0±0.1 mm.

Comparative netting was prepared from cord based on multifilament UHMWPE yarn SK78-440 dtex, commercially available under the trade name Dyneema from DSM. Cords were prepared by twisting 13 yarns together to form a strand, and combining 4 strands to form a cord. The cord had a diameter of 2.5±0.2 mm.

Netting with a half mesh size of about 28 mm was prepared from both cords.

Netting according to the invention and Comparative netting were immersed side by side at three locations with different fouling conditions at three different depths in the North sea (Netherlands territorial waters, subject to tide, netting depth selected such that the netting was submerged at all times). Thus, in total nine samples of each type of netting were tested. The test locations were not accessible to the public.

The netting was inspected visually for fouling after 2.5 weeks, 7 weeks, and 11 weeks, calculated from the date of immersion. It appeared that at all locations and independent from the immersion time, the netting according to the invention showed less fouling than the comparative netting. Not only was less growth of organisms seem on the netting according to the invention at all locations, the netting was also easier to clean. The netting according to the invention could be cleaned at lower water pressure in the cleaning apparatus than the comparative netting, resulting in a lower water consumption.

1. Netting suitable for use in aquaculture which has a half mesh size of 5-100 mm measured in accordance to ISO 1107:2017 and which comprises cord having a diameter of 0.5-8 mm, wherein the cord comprises films of ultra-high molecular weight polyethylene, the films having a width of 0.5-10 mm.

2. Netting according to claim 1, wherein the netting has a half mesh size in the range of 10-70 mm.

3. Netting according to claim 1, wherein the cord has a diameter of 1-6 mm.

4. Netting according to claim 1, wherein the ultra-high molecular weight polyethylene films have a width of at least 1 mm and at most 8 mm.

5. Netting according to claim 1, wherein the ultra-high molecular weight polyethylene films have a thickness in the range of 10-150 micron.

6. Netting according to claim 1, wherein the number of films in the cord is in the range of 1 to 500.

7. Netting according to claim 1 wherein the ultra-high molecular weight polyethylene films have a 200/100 uniplanar orientation parameter of at least 3.

8. Netting according to claim 1, wherein the ultra-high molecular weight polyethylene films have a polymer solvent content of less than 0.05 wt. %.

9. Netting according to claim 1, wherein the UHMWPE film is substantially free from finish and antifouling composition.

10. Netting according to claim 1, wherein the cord consists for at least 50 wt. % of UHMWPE film.

11. Netting according to claim 1 wherein the film consists for at least 95 wt. % of UHMWPE.

12. Netting according to claim 1 wherein the cord consists for at least 95 wt. % of UHMWPE.

13. Fish pen comprising netting according to claim 1.

14. Method for culturing fish, wherein fish are cultured in a fish pen comprising netting according to claim 1.
